(19) United States
(12) Patent Application Publication
(10) Pub. No.: US 2022/0226759 A1
(43) Pub. Date: Jul. 21, 2022

(54) Natural Gas Filter Apparatus

(71) Applicant: Harry Grant, New Liskeard (CA)

(72) Inventor: Harry Grant, New Liskeard (CA)

(21) Appl. No.: 17/151,759

(22) Filed: Jan. 19, 2021

(51) Int. Cl. B01D 45/08; C10L 3/10

(52) U.S. Cl. CPC B01D 45/08; C10L 2290/547; C10L 3/101

(57) ABSTRACT

A natural gas filter apparatus for preventing mercaptan buildup in appliances includes a filter sidewall coupled to a filter bottom side. The filter sidewall extends perpendicularly from a bottom perimeter of the filter bottom side. A front face of the filter sidewall has an inlet aperture extending therethrough. A back face of the filter sidewall has a drain aperture and an outlet aperture extending therethrough. The inlet aperture receives a gas regulator, the drain aperture receives a drain hose, and the outlet aperture receives a gas hose connected to an appliance. A baffle is coupled to the filter bottom side. The baffle has a front wall extending from the front face of the filter sidewall and a back wall extending from the back face of the filter sidewall between the drain aperture and the outlet aperture. A lid is coupled to the filter sidewall.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to gas filter devices and more particularly pertains to a new gas filter device for preventing mercaptan buildup in appliances.

### (2) Description of Related Art Including Information Disclosed Under 37 CFR 1.97 and 1.98

The prior art relates to gas filter devices. Existing devices require a filter with multiple components or a replaceable filtering medium. Some devices utilize a permeable media or a liquid. No devices are made of only two pieces with a baffle filter that can be easily cleaned.

### BRIEF SUMMARY OF THE INVENTION

An embodiment of the disclosure meets the needs presented above by generally comprising a filter bottom side and a filter sidewall coupled to the filter bottom side. The filter sidewall extends perpendicularly from a bottom perimeter of the filter bottom side. A front face of the filter sidewall has an inlet aperture extending therethrough. A back face of the filter sidewall has a drain aperture and an outlet aperture extending therethrough. The inlet aperture is configured to selectively receive a gas regulator, the drain aperture is configured to selectively receive a drain hose, and the outlet aperture is configured to selectively receive a gas hose connected to an appliance. A baffle is coupled to the filter bottom side. The baffle has a front wall extending from the front face of the filter sidewall and a back wall extending from the back face of the filter sidewall between the drain aperture and the outlet aperture. A lid is coupled to the filter sidewall and conforms to an upper perimeter of the filter sidewall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a natural gas filter apparatus according to an embodiment of the disclosure.

FIG. 2 is an isometric view of an embodiment of the disclosure.

FIG. 3 is a front elevation view of an embodiment of the disclosure.

FIG. 4 is a rear elevation view of an embodiment of the disclosure.

FIG. 5 is a top plan view of an embodiment of the disclosure.

FIG. 6 is a bottom plan view of an embodiment of the disclosure.

FIG. 7 is an in-use view of an embodiment of the disclosure.

### DETAILED DESCRIPTION OF THE INVENTION

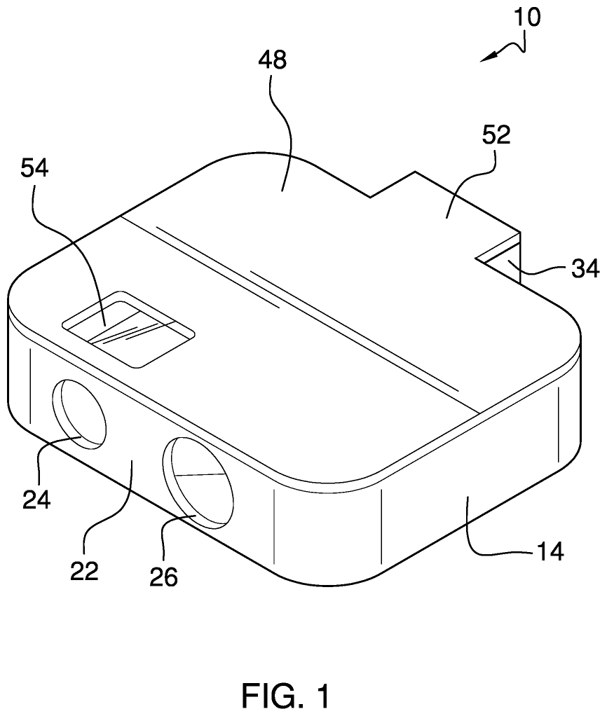

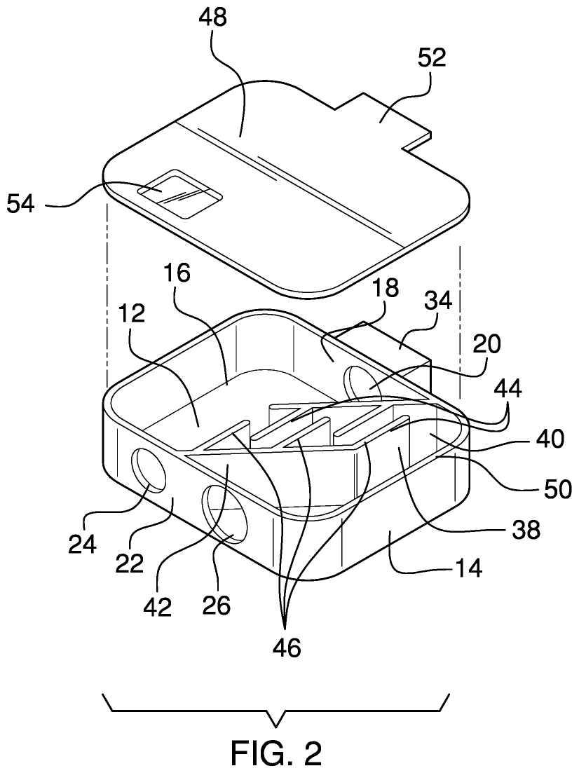

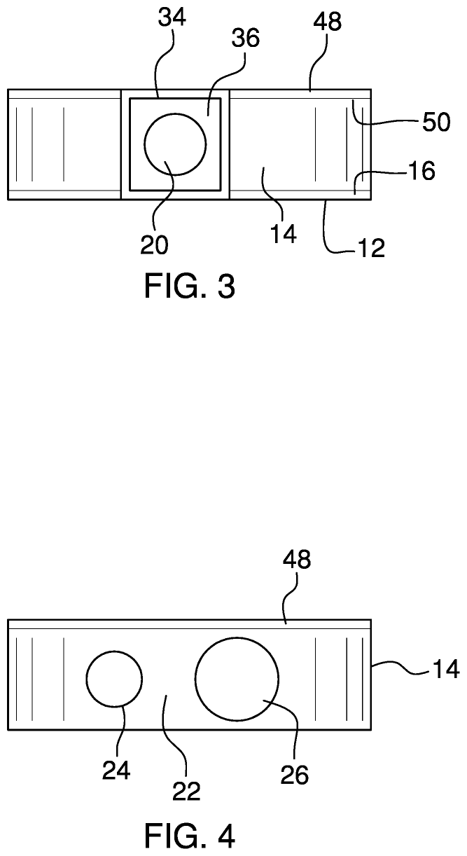

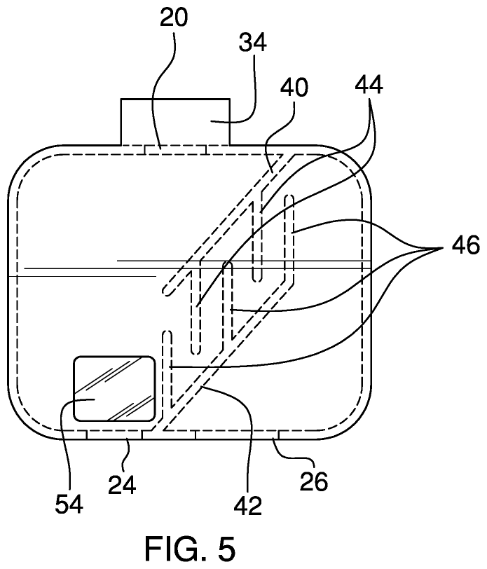

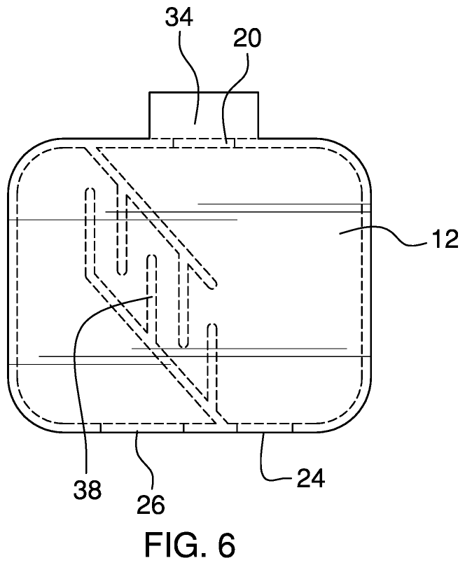

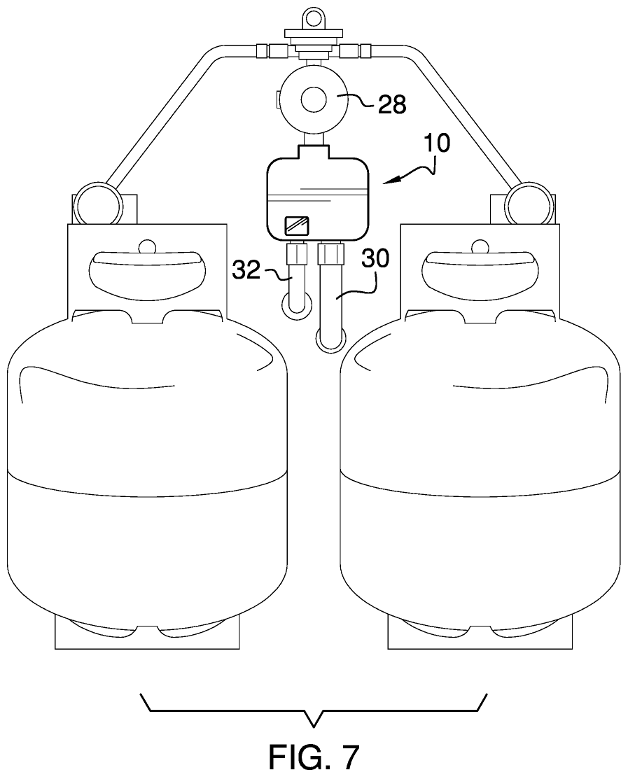

With reference now to the drawings, and in particular to FIGS. 1 through 7 thereof, a new gas filter device embodying the principles and concepts of an embodiment of the disclosure and generally designated by the reference numeral 10 will be described.

As best illustrated in FIGS. 1 through 7, the natural gas filter apparatus 10 generally comprises a filter bottom side 12 and a filter sidewall 14 coupled to the filter bottom side 12. The filter sidewall 14 extends perpendicularly from a bottom perimeter 16 of the filter bottom side. The filter sidewall 14 may have rounded corners for ease of cleaning.

A front face 18 of the filter sidewall has an inlet aperture 20 extending therethrough. A back face 22 of the filter sidewall has a drain aperture 24 and an outlet aperture 26 extending therethrough. The outlet aperture 26 may be larger than the drain aperture 24. The inlet aperture 20 is configured to selectively receive a gas regulator 28. The drain aperture 24 is configured to selectively receive a drain hose 30 and the outlet aperture 26 is configured to selectively receive a gas hose 32 connected to an appliance.

An inlet guard 34 may be coupled to the filter sidewall 14. The inlet guard 34 extends perpendicularly from the front face 18 around the inlet aperture 20. The inlet guard 34 may be rectangular prismatic with an inlet extension aperture 36 extending to the inlet aperture 20.

A baffle 38 is coupled to the filter bottom side 12. The baffle 38 has a front wall 40 extending from the front face 18 of the filter sidewall and a back wall 42 extending from the back face 22 of the filter sidewall between the drain aperture 24 and the outlet aperture 26. The front wall 40 and the back wall 42 may be parallel and may extend at a 45° angle from the front face 18 and the back face 22 of the filter sidewall, respectively. The front wall 40 may have a pair of front wall extensions 44 extending towards the back wall 42 and the back wall 42 may have a plurality of back wall extensions 46 extending towards the front wall 40. Each front wall extension 44 and each back wall extension 46 may be perpendicular to the front face 18 and the back face 22 of the filter sidewall. The front wall extensions 44 and the back wall extensions 46 may be evenly spaced and arranged to alternate such that the gas from the inlet aperture 20 must follow a zigzag path to reach the outlet aperture 26.

A lid 48 is coupled to the filter sidewall 14. The lid 48 conforms to an upper perimeter 50 of the filter sidewall excepting an extension portion 52 conforming to the inlet guard 34. The lid may have a window 54 positioned proximal the drain aperture 24 to allow a user to see when mercaptan buildup needs to be cleaned out.

In use, gas comes through the gas regulator 28 into the inlet aperture 20 and travels through the baffle 38 and out the outlet aperture 26 to the gas hose 32. As the gas travels through the apparatus 10, mercaptan is captured on the filter sidewall 14 and the baffle 38 and exits through the drain aperture 24 to the drain hose 30 rather than damaging connected appliances.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A natural gas filter apparatus comprising:
a filter bottom side;
a filter sidewall coupled to the filter bottom side, the filter sidewall extending perpendicularly from a bottom perimeter of the filter bottom side, a front face of the filter sidewall having an inlet aperture extending therethrough, a back face of the filter sidewall having a drain aperture and an outlet aperture extending therethrough, the inlet aperture being configured to selectively receive a gas regulator, the drain aperture being configured to selectively receive a drain hose, and the outlet aperture being configured to selectively receive a gas hose connected to an appliance;
a baffle coupled to the filter bottom side, the baffle having a front wall extending from the front face of the filter sidewall and a back wall extending from the back face of the filter sidewall between the drain aperture and the outlet aperture; and
a lid coupled to the filter sidewall, the lid conforming to an upper perimeter of the filter sidewall.

2. The natural gas filter apparatus of claim 1 further comprising the lid having a window.

3. The natural gas filter apparatus of claim 2 further comprising the window being positioned proximal the drain aperture.

4. The natural gas filter apparatus of claim 1 further comprising an inlet guard coupled to the filter sidewall, the inlet guard extending perpendicularly from the front face around the inlet aperture.

5. The natural gas filter apparatus of claim 4 further comprising the lid having an extension portion conforming to the inlet guard.

6. The natural gas filter apparatus of claim 1 further comprising the filter sidewall having rounded corners.

7. The natural gas filter apparatus of claim 1 further comprising the outlet aperture being larger than the drain aperture.

8. The natural gas filter apparatus of claim 1 further comprising the front wall and the back wall being parallel.

9. The natural gas filter apparatus of claim 1 further comprising the front wall and the back wall extending at a 45° angle from the front face and the back face of the filter sidewall, respectively.

10. The natural gas filter apparatus of claim 8 further comprising the front wall having a pair of front wall extensions extending towards the back wall and the back wall having a plurality of back wall extensions extending towards the front wall, each front wall extension and each back wall extension being perpendicular to the front face and the back face of the filter sidewall.

11. A natural gas filter apparatus comprising:
a filter bottom side;
a filter sidewall coupled to the filter bottom side, the filter sidewall extending perpendicularly from a bottom perimeter of the filter bottom side, the filter sidewall having rounded corner, a front face of the filter sidewall having an inlet aperture extending therethrough, a back face of the filter sidewall having a drain aperture and an outlet aperture extending therethrough, the outlet aperture being larger than the drain aperture, the inlet aperture being configured to selectively receive a gas regulator, the drain aperture being configured to selectively receive a drain hose, and the outlet aperture being configured to selectively receive a gas hose connected to an appliance;
an inlet guard coupled to the filter sidewall, the inlet guard extending perpendicularly from the front face around the inlet aperture;
a baffle coupled to the filter bottom side, the baffle having a front wall extending from the front face of the filter sidewall and a back wall extending from the back face of the filter sidewall between the drain aperture and the outlet aperture, the front wall and the back wall being parallel and extending at a 45° angle from the front face and the back face of the filter sidewall, respectively, the front wall having a pair of front wall extensions extending towards the back wall and the back wall having a plurality of back wall extensions extending towards the front wall, each front wall extension and each back wall extension being perpendicular to the front face and the back face of the filter sidewall; and
a lid coupled to the filter sidewall, the lid conforming to an upper perimeter of the filter sidewall excepting an extension portion conforming to the inlet guard, the lid having a window positioned proximal the drain aperture.
